(19) United States
(12) Patent Application Publication
(10) Pub. No.: US 2026/0352675 A1
(43) Pub. Date: Nov. 5, 2026

(54) PROFILING MACHINE AND USER BEHAVIOR USING VECTOR EMBEDDING

(71) Applicant: Cisco Technology, Inc., San Jose, CA (US)

(72) Inventors: Robert Edgar Barton, Richmond (CA); Anand Raghavan, Santa Clara, CA (US); Bhavik Pradeep Shah, Bangalore (IN); Barry Qi Yuan, Vancouver (CA)

(21) Appl. No.: 19/249,950

(22) Filed: Jun. 25, 2025

Related U.S. Application Data
(60) Provisional application No. 63/800,238, filed on May 5, 2025.

(51) Int. Cl. H04L 9/40

(52) U.S. Cl. CPC H04L 63/1416

(57) ABSTRACT

Techniques and mechanisms for a network-profiling system to create an embedding model that converts entity behaviors into multi-dimensional vector representations. The network-profiling system obtains telemetry data that represents network behaviors of the entities and identity data representing identities of the entities. Using the telemetry data and identity data, the network-profiling system trains an embedding model to transform and store entity behavior into a vector representation. Once the training of the embedding model is complete, a multi-dimensional vector embedding or representation of each entity has been created. Using these vector embeddings, the network-profiling system can determine semantic relationships between the entities in the vector space. For instance, entities that exhibit similar and safe behavior will have a geographically close vector representations and be classified as “safe,” whereas entities that exhibit similar and dangerous behavior will be classified as “dangerous,” and various actions can be taken based on these classifications.

### TECHNICAL FIELD

This application claims priority to U.S. Provisional Application No. 63/800,238, filed on May 5, 2025, the entire contents of which are incorporated herein by reference.

### TECHNICAL FIELD

The present disclosure relates generally to profiling machine, application, and user behavior using vector embedding, and analyzing the behavior across multiple dimensions for anomaly detection, behavior clustering, and Zero Trust.

### BACKGROUND

As organizations increasingly adopt cloud services, distributed workforces, and interconnected device ecosystems, the importance of securing enterprise networks has grown dramatically. A foundational principle in modern cybersecurity strategies is Zero Trust Architecture (ZTA)—a security framework that mandates the principle of “never trust, always verify.” Under this model, users, devices, and services are granted only the minimal level of access necessary to perform their intended functions, thereby reducing the overall attack surface. However, implementing this principle effectively presents a significant technical challenge, that is, determining what constitutes “minimum necessary access” for each entity in an environment characterized by complex and dynamic user and system behaviors.

Traditional approaches to behavioral analysis rely on a number of independent techniques to monitor and characterize user and machine activity. These include analysis of traffic flow logs (e.g., NetFlow or sFlow), access logs (e.g., login attempts and session data), device fingerprinting, application usage monitoring, temporal pattern analysis, enterprise data platform analyzers, and Security Information Management Systems (SIMS). Each of these systems provide narrow, domain-specific views of behavior and risk, typically producing large volumes of alerts based on rule-based or statistical anomaly detection.

While these monitoring tools can be useful in detecting potentially anomalous or malicious behavior in certain domains, they are narrow in perspective and frequently suffer from false positives, diminishing their use and effectiveness. For example, a hacked system may not exhibit anomalous from one dimension alone, but if behaviors are examined in combination, it may indicate it is compromised. In other words, looking at each dimension of behavior in isolation may not provide useful information, but looked at holistically this can be a powerful tool to indicate a problem. As an example, certain security incidents may not be evident from any single behavioral signal, but could be detectable when multiple dimensions are considered in combination. This lack of correlation and contextualization between sources increases the risk of false positives, leading to alert fatigue among security analysts and ultimately reducing the effectiveness of the monitoring tools.

Accordingly, there exists a need for systems and methods that enable a more comprehensive, multi-dimensional analysis of behavioral data across users, devices, and services. By integrating and embedding diverse behavioral signals into a unified representation, it becomes possible to model “normal” versus “suspicious” behavior more accurately and to dynamically inform access control decisions in line with zero trust principles. Such an approach could significantly improve detection accuracy, reduce false positives, and allow for more granular, adaptive access controls without compromising business continuity.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment in which a network-profiling system creates and uses an embedding model that converts entity behaviors into multi-dimensional vector representations.

FIG. 2 illustrates a component diagram of an example network-profiling system as described herein.

FIG. 3 illustrates an example diagram of a network-profiling system that creates an embedding model configured to convert network behaviors of entities into vector representations in a vector space.

FIG. 4 illustrates an example diagram of a network-profiling system that uses an embedding model to determine if entities are safe or hacked.

FIG. 5 illustrates a flow diagram of an example method for a network-profiling system to create an embedding model configured to profile behaviors of entities communicating using networks.

FIG. 6 illustrates a flow diagram of an example method for a network-profiling system to use an embedding model configured to determine that an entity is behavior unsafe.

FIG. 7 is a computing system diagram illustrating a configuration for a data center that can be utilized to implement aspects of the technologies disclosed herein.

FIG. 8 is a computer architecture diagram showing an example computer architecture for a device capable of executing program components that can be utilized to implement aspects of the various technologies presented herein.

### DESCRIPTION OF EXAMPLE EMBODIMENTS

### Overview

The present disclosure relates generally to creating an embedding model configured to profile entities communicating using networks, and using the embedding model to categorize entity behavior as safe or unsafe.

A first method described herein may include collecting telemetry data from network-monitoring systems that monitor networks where the telemetry data represents behaviors of the entities communicating in the networks. The first method may further include obtaining identity data that indicates identities for each of the entities, and using the telemetry data and the identity data, training an embedding model to map the behaviors for each of the identities of the entities into a vector space that includes vector representations with multiple dimensions. Further, the first method may include determining that first vector representations in a first region of the vector space represent first behaviors that are safe, and determining that second vector representations in a second region of the vector space represent second behaviors that are unsafe. Additionally, the first method may include classifying first entities, of the entities, as operating under safe conditions based at least in part on the first entities corresponding to the first vector representations, and classifying second entities, of the entities, as operating under unsafe conditions based at least in part on the second entities corresponding to the second vector representations. In some examples, the first method also includes determining that a particular vector representation is associated with the second region and determining that the particular vector representation represents particular behaviors of a particular entity that are unsafe based at least in part on the particular vector representation being associated with the second region.

A second method described herein may include monitoring, by a network-profiling system, behaviors of entities communicating in networks to determine if the entities are exhibiting unsafe behaviors. Further, the second method may include storing, at the network-profiling system, an embedding model that is configured to map the behaviors for identities of entities into a vector space that includes vector representations with multiple dimensions. In some examples, first vector representations in a first region of the vector space represent first behaviors that are safe, and second vector representations in a second region of the vector space represent second behaviors that are unsafe. The second method may additionally include determining that a particular vector representation is associated with the second region, and determining that the particular vector representation represents particular behaviors of a particular entity that are unsafe based at least in part on the particular vector representation being associated with the second region.

Additionally, the techniques of at least the first method and second method, and any other techniques described herein, may be performed by a system and/or device having non-transitory computer-readable media storing computer-executable instructions that, when executed by one or more processors, performs the method(s) described above.

### EXAMPLE EMBODIMENTS

The field of language modeling has evolved significantly over the past several decades. Early approaches to representing language in computational systems were relatively rudimentary—individual words were indexed using unique numerical identifiers. While this indexing approach enabled basic text processing, it failed to capture any meaningful semantic or syntactic relationships between words. As the field matured, researchers recognized that the depth and nuance of natural language required far more sophisticated representational techniques.

A breakthrough in language modeling came with the introduction of neural network-based techniques for learning vector representations of words (e.g. Word2Vec™ by Google®). This new approach to language modeling employs a neural network to learn distributed representations of words from a large corpus of text, such as Wikipedia. In this model, each word (or token) in the vocabulary is mapped to a high-dimensional vector within a continuous vector space. For example, Word2Vec™ commonly employs 300-dimensional vectors to represent individual words. These embeddings reflect semantic proximity such that words with similar meanings tend to occupy neighboring regions in the vector space.

Subsequent advancements in embedding technologies have led to increasingly rich and expressive representations. For instance, language models from OpenAI™ have generated word embeddings with dimensionalities as high as 12,288, allowing for a more granular encoding of semantic nuances across millions of textual examples. The increased dimensionality enhances the model's ability to capture context-specific subtleties and relationships between tokens.

One of the key advantages of word embeddings is their ability to represent words as mathematical vectors in an n-dimensional space, where words that have semantic similarity tend to have close geometric proximity in the vector space. This enables novel capabilities such as identifying semantically related words, distinguishing between synonyms and antonyms, and performing vector arithmetic that reveals analogical relationships. Additionally, embedding-based representations facilitate the clustering of related terms, effectively organizing the language space into meaningful conceptual groupings.

For example, when visualizing embeddings in a reduced-dimensional space (e.g., 3D using Principal Component Analysis (PCA) or t-distributed Stochastic Neighbor Embedding (t-SNE)), a token like “security” may appear in close proximity to other semantically related terms such as “privacy,” “safety,” and “protection,” while being distinctly separated from unrelated terms. These spatial relationships illustrate the power of embedding models in enabling machines to reason about language with a degree of semantic awareness. This foundational work in vector-based language modeling has opened the door to a broad range of modern natural language processing applications, including search relevance, question answering, and text classification, and continues to be an area of active innovation.

This disclosure describes techniques for a network-profiling system to create an embedding model that converts entity behaviors (e.g., users, machines, or applications) into multi-dimensional vector representations. The network-profiling system may obtain telemetry data from various network-monitoring systems that represents network behaviors of the entities (e.g., access patterns, traffic patterns, Syslog files, Security logs, etc.) as well as identity data for the entities. Using the telemetry data and identity data as a corpus of text, the network-profiling system trains an embedding neural network (also referred to herein as an “embedding model”) to transform and store entity behavior into a vector representation. Once the training of the embedding model is complete, a multi-dimensional vector representation of each entity has been created. Generally, the number of dimensions used to represent each entity depends on various metrics, such as the complexity of the network-monitoring systems and the number of entities.

Once a vector embedding is created for each entity, the network-profiling system can explore the semantic relationships between the entities in the vector space. For example, entities that exhibit similar and safe behavior will have a geographically close vector representation, and this becomes a useful way to group similar types of devices according to their vector representation and to classify users as “safe” or “compliant” as well as “hacked” or “dangerous.” Various access controls and security controls may be layered on top of these categorized vector spaces. For example, if a user begins to move or appears in the “dangerous” area of the vector space, it possibly means they have been compromised and security controls for this user can be enabled.

Initially, the network-profiling system may access and obtain telemetry data from network-monitoring systems, such as various types of logs, traces, events, or metrics. For instance, the network-profiling system may have Application Programming Interface (API) access to a multitude of back-end logging and security systems where user, application, and machine behaviors are stored. The network-monitoring systems may obtain traffic flow logs (e.g., from a NetFlow® collector), access logs (e.g., web access logs), network security monitoring logs (e.g., Snort®), network incident logs (e.g., Splunk®), device profiling data, user profiling data, system log files (e.g., Syslog files), application use data, enterprise network data, etc. The network-monitoring system may subscribe to this data from the network-monitoring systems, or may be included in the network-monitoring systems and offered as a feature.

Further, the network-profiling system may obtain identity data to determine identities of the entities across the different network-monitoring systems. The identity data can be obtained from various identity sources, such as Identity Services Engine (ISE), Lightweight Directory Access Protocol (LDAP), Active Directory, etc. The identities may need to be normalized across the different identity sources prior to use for training the embedding model. In this way, a consistent identity for each identity may be associated with different pieces of telemetry data across all the different network-monitoring systems.

The network-profiling system uses the telemetry data and identity data as corpus of text to train the embedding model, which may be a neural network. The neural network is trained to transform and store the entity behavior as vector representations. For each network-monitoring system that provides data used to train the embedding model, the entity identity must be associated with log entries. By way of analogy, a word embedding algorithm typically employs methods such as skip-gram or Continuous Bag of Words (CBOW) to associate surrounding words with the word that is being trained. As described in this disclosure, an established identity of the entity is associated with the various logging data (e.g., network behaviors) collected for the entities in order to describe the entities during the training process.

In some instances, the training data used to train the embedding model may be from real-world networks (with permission), obfuscation of any personally identifiable information (PII) data will be necessary, such as Internet Protocol (IP) or Media Access Control (MAC) addresses. In these cases, the embedding model can still be trained, but the actual addresses will be hidden, and other attributes will be leveraged.

Once the embedding model is trained, a multi-dimensional vector representation of each entity (e.g., user, machine/device, application, etc.) is created and stored. The number of dimensions used to represent each entity may depend on various metrics, such as the complexity of the back-end logging systems, the number of entities, etc. Importantly, it may not be necessary to define what each dimension actually represents-rather, the more dimensions that are established provides the embedding model with a multiplicity of ways to describe the entity in its own way. Thus, the network-profiling system is provided with a more comprehensive way to represent a user, machine, or even an application (or underlying protocol). That is, rather than relying on one network-monitoring system to determine behavior, the network-profiling system employs a holistic mathematical representation of the entity.

In some instances, the vector representation of the entities may be updated by the network-profiling system through fine-tuning of the embedding model over time as the behavior of entities changes, or new entities are added.

Using the vector embeddings created for each entity using the embedding model, the network-profiling system is able to identity various semantic relationships in the vector space, and perform various classifications of vector groups. For example, entities that exhibit similar behaviors may have geographically “close” vector representations (that is, their cosine similarity will be close to 1 because the vector angle is close to 0). This now becomes a useful way to group similar types of devices according to their vector representation, and to classify entities based on common behaviors.

As an example, an industrial device, such as a Programmable Logic Controller (PLC) should almost always act in a predictable way. However, if the PLC begins to act differently, it may be compromised. According to the techniques of this disclosure the network-profiling system is able to use a normalization vector to represent PLCs in a generalized way—however, if a PLC in the customer network is not in the same area of the vector space (i.e. the angle between the vectors is large and the cosine similarity is close to 0) this may indicate a compromised PLC.

The network-profiling system may utilize the embedding model and resulting vector representations for security purposes. For instance, the network-profiling system may define clusters in the vector space that would be considered “safe” for an entity. Conversely, other clusters in the vector space may be identified as “suspicious”, “dangerous”, or even “hacked.” The network-profiling system may utilize various algorithms for this, such as Support Vector Machine (SVM).

There are many different use cases in which the embedding model and vector representations may be used. For instance, the techniques described herein may be utilized for employment of security controllers. Once the network-profiling system begins to analyze the semantic relationships of entities, the network-profiling system (and/or other entities) may begin to layer on security controls. For example, if an entity begins to move, or appears in the “dangerous” area of the vector space, it possibly means they have been compromised and the network-profiling system (or other entity) may apply security controls to the entity.

The network-profiling system may utilize the vector space to not only (i) identify vectors that are compromised and are in a non-compliant area of the vector space, but may also (ii) identify vectors that are moving over time. In this way, the network-profiling system may identify vectors that are gradually moving towards a non-compliant area of the vector space and may put a “watch” on these vectors to monitor them and prevent them from becoming dangerous or hacked.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

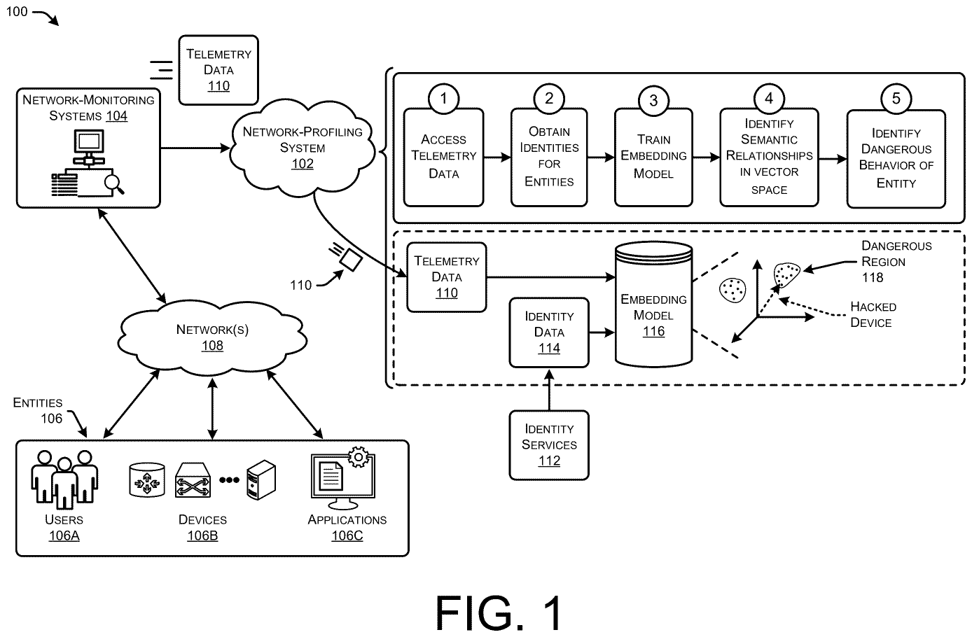

FIG. 1 illustrates a system-architecture diagram of an environment 100 in which a network-profiling system 102 creates and uses an embedding model that converts entity behaviors into multi-dimensional vector representations.

The network-profiling system 102 may comprise one or more computing devices and software or code running on the device(s). The network-profiling system 102 may be a cloud-based service or system, an enterprise system, a software-as-a-service (SaaS) infrastructure, or any other kind of system. Generally, the network-profiling system 102 is configured to communicate with network-monitoring systems 104 in order to determine network behaviors of entities 106 that are communicating over one or more networks 108.

The network(s) 108 may comprise any type of network, such one or more networks implemented by any viable communication technology, such as wired and/or wireless modalities and/or technologies. The network(s) 108 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)-both centralized and/or distributed-and/or any combination, permutation, and/or aggregation thereof. The network(s) 108 may include devices, virtual resources, or other nodes that relay packets from one network segment to another by nodes in the computer network. Network(s) 108 may include multiple devices that utilize the network layer (and/or session layer, transport layer, etc.) in the OSI model for packet forwarding, and/or other layers.

The network-profiling system 102 interacts with the network-monitoring systems 104 and potentially other entities (e.g., identity services 112) to create an embedding model 116 that converts behaviors of the entities 106 into multi-dimensional vector representations. The entities106 may include users 106A, devices 106B, applications 106C, and/or other entities that may communicate over, or otherwise interact with, the network(s) 108 and associated devices. The devices 106B may comprise any type of device, such as computing devices (e.g., laptops, desktops, servers), mobile devices (e.g., smartphones, tablets), network infrastructure devices (e.g., routers, switches, access points), IoT devices (e.g., smart thermostats, security cameras, smart light bulbs), industrial equipment (e.g., PLCs, SCADA systems, CNC machines), and peripherals (e.g., network printers, IP cameras, VoIP phones). Further, the applications 106C may comprise any type of application or process, such as web services (e.g., web browsers, APIs, content delivery networks), email services (e.g., mail clients, SMTP/IMAP servers), file transfer tools (e.g., FTP clients, cloud storage sync apps), collaboration platforms (e.g., video conferencing, messaging apps, shared document editors), system management tools (e.g., remote desktop, SSH, SNMP monitoring), background services (e.g., software updaters, telemetry agents, licensing checks), and virtual resources (e.g., virtual machines, containers, serverless functions).

At “1”, the network-profiling system 102 may access and obtain telemetry data 110 from the network-monitoring systems 104, such as various types of logs, traces, events, or metrics. For instance, the network-profiling system 102 may have API access to a multitude of back-end logging and security systems where user 106A, device 106B, and application 106C behaviors are stored. The network-monitoring systems 104 may obtain traffic flow logs (e.g., from a NetFlow® collector), access logs (e.g., web access logs), network security monitoring logs (e.g., Snort®), network incident logs (e.g., Splunk®), device profiling data, user profiling data, system log files (e.g., Syslog files), application use data, enterprise network data, etc. The network-profiling system 102 may subscribe to this data from the network-monitoring systems 104, or may be included in the network-monitoring systems 104 and offered as a feature.

Further, the network-profiling system 102 may, at “2”, obtain identity data 114 to determine identities of the entities 106 across the different network-monitoring systems. The identity data 114 can be obtained from various identity services 112 or sources, such as Identity Services Engine (ISE), Lightweight Directory Access Protocol (LDAP), Active Directory, etc.

The identities in the identity data 114 may need to be normalized across the different identity service 112 prior to use for training the embedding model 116. In this way, a consistent identity for each of the entities 106 may be associated with different pieces of telemetry data 110 across all the different network-monitoring systems 104.

The network-profiling system 102 uses the telemetry data 110 and identity data 114 as corpus of text to train the embedding model 116 (at “4”), which may be a neural network. The embedding model 116 is trained to transform and store behaviors of the entities 106 as vector representations. For each network-monitoring system 104 that provides data used to train the embedding model 116, the identity of the entities 106 must be associated with log entries. By way of analogy, a word embedding algorithm typically employs methods such as skip-gram or CBOW to associate surrounding words with the word that is being trained. As described in this disclosure, an established identity for each the entities 106 is associated with the various logging data (e.g., network behaviors) collected for the entities 106 in order to describe the entities 106 during the training process.

As noted above, just as Word2Vec learns vector representations of words based on the context in which they appear in sentences, the embedding model 116 may be trained to create vector representations for network behaviors of the entities 106 based on how the entities 106 communicate within the network(s) 108. In this analogy, each “word” is a device or a device-action (such as a device initiating a connection on a certain port or protocol), and each “sentence” is a sequence of network communication events over a short time window. These sequences might include which of the entities 106 communicated with each other, over which protocols, at what times, and with what frequency or volume. Using models similar to Word2Vec—such as Skip-Gram, which predicts the context given a device, or CBOW, which predicts a device given its communication context—the system can learn behavioral patterns. Over time, the embedding model 116 builds embeddings where similar vectors represent devices with similar roles or traffic behaviors (e.g., two printers or two web servers might end up near each other in the embedding space). These embeddings can then be used for clustering, anomaly detection, or role inference in network security and monitoring applications.

In some instances, the training data used to train the embedding model 116 may be from real-world networks (with permission), obfuscation of any PII data will be necessary, such as IP or MAC addresses. In these cases, the embedding model 116 can still be trained, but the actual addresses will be hidden, and other attributes will be leveraged.

Once the embedding model 116 is trained, a multi-dimensional vector representation of each of the entities 106 (e.g., user 106A, device 106B (or machine), application 106C, etc.) is created and stored. The number of dimensions used to represent each of the entities 106 may depend on various metrics, such as the complexity of the back-end logging systems, the number of the entities 106, etc. Importantly, it may not be necessary to define what each dimension actually represents-rather, the more dimensions that are established provides the embedding model 116 with a multiplicity of ways to describe each of the entities 106 in its own way. Thus, the network-profiling system 102 is provided with a more comprehensive way to represent a user 106A, device 106B, or application 106C (or underlying protocol). That is, rather than relying on a single one of network-monitoring systems 104 to determine behavior, the network-profiling system 102 employs a holistic mathematical representation of the entity from a plurality of the network-monitoring systems 104.

In some instance, the vector representation of the entities 106 may be updated by the network-profiling system 102 through fine-tuning of the embedding model 116over time as the behavior of entities 106 changes, or new ones of the entities 106 are added.

Using the vector embeddings created for each entity using the embedding model, the network-profiling system 102 is able to (at “4”) identity various semantic relationships in the vector space, and perform various classifications of vector groups. For example, entities 106 that exhibit similar behaviors may have geographically “close” vector representations (that is, their cosine similarity will be close to 1 because the vector angle is close to 0). This now becomes a useful way to group similar types of entities 106 according to their vector representation, and to classify entities 106 based on common behaviors.

As an example, an industrial device, such as a PLC, should almost always act in a predictable way. However, if the PLC begins to act differently, it may be compromised. According to the techniques of this disclosure the network-profiling system 102 is able to use a normalization vector to represent PLCs in a generalized way-however, if a PLC in the customer network is not in the same area of the vector space (i.e. the angle between the vectors is large and the cosine similarity is close to 0) this may indicate a compromised PLC.

The network-profiling system 102 may utilize the embedding model 116 and resulting vector representations for security purposes at “5”, such as identifying dangerous behavior of entities 106. For instance, the network-profiling system 102 may define clusters in the vector space that would be considered “safe” for an entity. Conversely, other clusters in the vector space (e.g., dangerous region 118) may be identified as “suspicious”, “dangerous”, or even “hacked.” The network-profiling system 102 may utilize various algorithms for this, such as Support Vector Machine (SVM).

There are many different use cases in which the embedding model 116 and vector representations may be used. For instance, the techniques described herein may be utilized for employment of security controllers. Once the network-profiling system 102 begins to analyze the semantic relationships of entities 106, the network-profiling system 102 (and/or other entities 106) may begin to layer on security controls. For example, if an entity begins to move, or appears in a dangerous region 118 of the vector space, it possibly means they have been compromised and the network-profiling system 102 (or other entity) may apply security controls to the entity.

The network-profiling system 102 may utilize the vector space to not only (i) identify vectors that are compromised and are in a non-compliant area of the vector space (e.g., dangerous region 118), but may also (ii) identify vectors that are moving over time. In this way, the network-profiling system 102 may identify vectors that are gradually moving towards a non-compliant area of the vector space and may put a “watch” on these vectors to monitor them and prevent them from becoming dangerous or hacked.

While some of the techniques are described herein as being performed by the network-profiling system 102 that is an independent entity, the network-profiling system 102 may be included in another system, such as one or more of the network-monitoring systems 104.

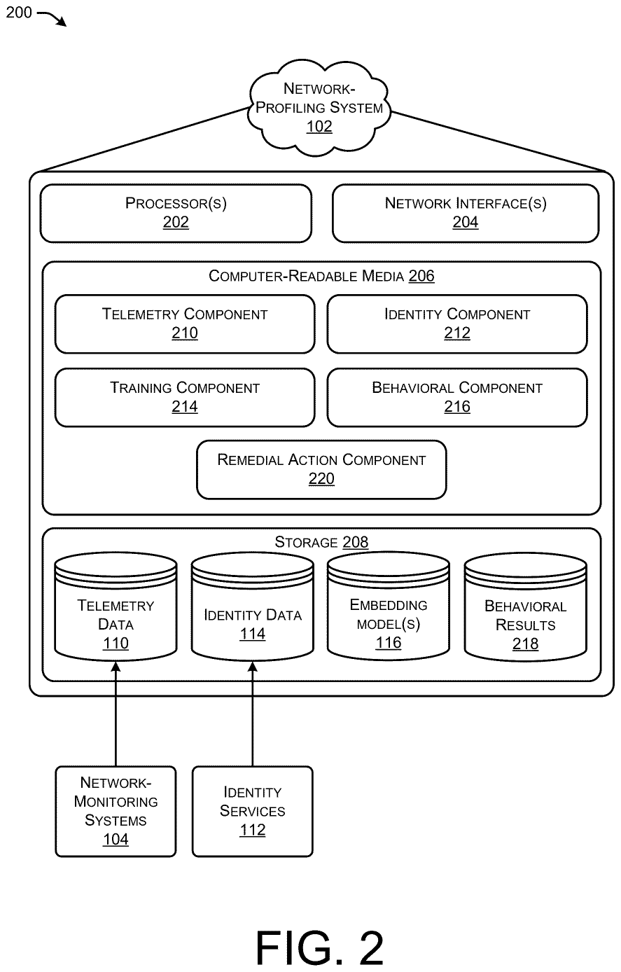

FIG. 2 illustrates a component diagram 200 of an example of the network-profiling system 102 as described herein.

As illustrated, the network-profiling system 102 may include one or more hardware processors 202 (processors), one or more devices, configured to execute one or more stored instructions. The processor(s) 202 may comprise one or more cores. Further, the network-profiling system 102 may include one or more network interfaces 204 configured to provide communications between the network-profiling system 102 and other devices, such as the network-monitoring systems 104 and/or other devices and systems or devices. The network interfaces 204 may include devices configured to couple to personal area networks (PANs), wired and wireless local area networks (LANs), wired and wireless wide area networks (WANs), and so forth.

The network-profiling system 102 may also include computer-readable media 206 that stores various executable components (e.g., software-based components, firmware-based components, etc.). The computer-readable media 206 may further store or be used to execute components to implement functionality described herein. While not illustrated, the computer-readable media 206 may store one or more operating systems utilized to control the operation of the one or more devices that comprise the network-profiling system 102. According to one embodiment, the operating system comprises the LINUX operating system. According to another embodiment, the operating system(s) comprise the WINDOWS® SERVER operating system from MICROSOFT Corporation of Redmond, Washington. According to further embodiments, the operating system(s) can comprise the UNIX operating system or one of its variants. It should be appreciated that other operating systems can also be utilized.

Additionally, the network-profiling system 102 may include storage 208 which may comprise one, or multiple, repositories or other storage locations for persistently storing and managing collections of data such as databases, simple files, binary, and/or any other data. The storage 208 may include one or more storage locations that may be managed by one or more database management systems.

The computer-readable media 206 may store portions, or components, of the network-profiling system 102 described herein. For instance, the computer-readable media 206 may store a telemetry component 210, an identity component 212, a training component 214, a behavioral component 216, and a remedial action component 220. These components may work together to process various data to generate and use one or more of the embedding models 116.

The data storage 208 may maintain several data stores, including telemetry data 110, identity data 114, embedding model(s) 116, and a behavioral results store 218. These data stores may provide persistent storage for the various types of data processed by the network-profiling system 102.

The telemetry component 210 may receive telemetry data 110 from various source, such as the network-monitoring systems 104. In some aspects, the telemetry component 210 may interface directly with the network-monitoring systems 104 to collect real-time data about network traffic, device activities, and user behaviors. The telemetry data 110 may include information such as network flows, packet captures, log files, and performance metrics. In some cases, the telemetry component 210 may employ data collection agents deployed across to gather telemetry data 110 from multiple points. These agents may be software modules installed on network devices, servers, or endpoints that continuously monitor and report relevant network activities.

The telemetry component 210 may also interact with the identity component 212 to associate the collected telemetry data 110 with corresponding identity data 114. This association may be accomplished through various methods, such as correlating IP addresses or device identifiers with user accounts or application instances. The identity data 114 may be obtained from identity services 112, which may include directory services, authentication systems, or identity and access management platforms.

The identity component 212 may process and manage identity data 114 received from identity services 112. In some aspects, this component may correlate identity information with telemetry data 110, associating network activities with specific users, devices, or applications. The identity component 212 may also perform identity verification and authentication tasks, ensuring that the identity data used in the system is accurate and up-to-date.

In some implementations, the telemetry component 210 may preprocess the incoming telemetry data 110, performing tasks such as data normalization, filtering, or aggregation before passing it to other components of the system. This preprocessing may help to standardize the data format and reduce noise in the collected telemetry information.

The training component 214 may utilize the processed telemetry data 110 and identity data 114 to create and update the embedding models 116. These embedding models 116 may transform raw data into vector representations that capture behavioral patterns of entities 106. In some implementations, the training component 214 may employ machine learning algorithms, such as neural networks or dimensionality reduction techniques, to generate these vector representations.

The behavioral component 216 may analyze patterns in the vector space representations generated by the embedding models 116. Results from this analysis may be stored in the behavioral results store 218. The remedial action component 220 may use these results to recommend actions when potentially unsafe behaviors are detected.

For instance, the behavioral component 216 may analyze the vector representations produced by the embedding models 116 to identify patterns and anomalies in network behavior. This component may cluster similar behaviors, detect outliers, and track changes in entity behavior over time. The behavioral component 216 may store its analysis results in the behavioral results store 218, which may serve as a repository for historical behavioral data and trends.

The remedial action component 220 may use the insights generated by the behavioral component 216 to recommend appropriate actions when potentially unsafe behaviors are detected. In some cases, this component may prioritize alerts based on the severity of detected anomalies and suggest specific remediation steps to network administrators.

These components may interact in a pipeline fashion. The identity component 212 may provide enriched identity information to the training component 214, which in turn generates vector representations for the behavioral component 216 to analyze. The behavioral component 216 may then feed its findings to the remedial action component 220 for action recommendations.

In some implementations, the behavioral component 216 may provide feedback to the training component 214, allowing the embedding models 116 to be refined based on newly identified behavioral patterns. The remedial action component 220 may also interact with the identity component 212 to gather additional context about entities involved in detected anomalies.

The network-profiling system 102 may allow for continuous learning and adaptation. As new telemetry data 110 and identity data 114 flow into the system, the components may update their models and analyses, enabling the network-profiling system 102 to evolve its understanding of normal and abnormal network behaviors over time.

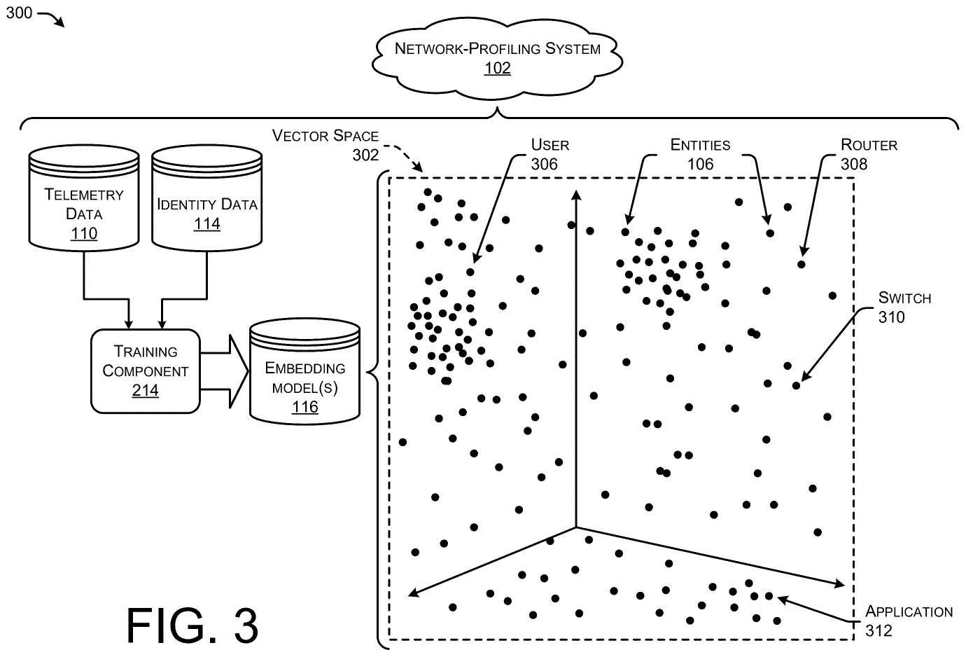

FIG. 3 illustrates an example diagram 300 of a network-profiling system 102 that creates an embedding model 116 configured to convert network behaviors of entities into vector representations in a vector space 302.

In some cases, the network profiling system 102 may process the telemetry data 110 and identity data 114 and use the training component 214 to train and/or generate the embedding model 116. The embedding model 116 may convert behavioral data of network entities into vector representations within the vector space 302.

The vector space 302 may contain vector representations of entity behavior with multiple dimensions, with each dimension potentially representing different aspects of entity behavior. In some implementations, the vector space 302 may include a user vector 306, a router vector 308, a switch vector 310, and an application vector 312. Each of these vectors may represent the behavioral characteristics of its corresponding network entity (e.g., any of the entities 106).

The positions of vector points within the vector space 302 may be significant. Vectors that are closer together in the space may indicate entities with similar behavioral patterns, while points that are farther apart may represent entities with dissimilar behaviors. In some cases, the network-profiling system 102 may use a normalization vector to represent a generalized behavior for a type of device. For example, a normalization vector may be used to represent the typical behavior of Programmable Logic Controllers (PLCs) in the network. This normalization vector may serve as a reference point for comparing the behavior of individual PLCs in the network.

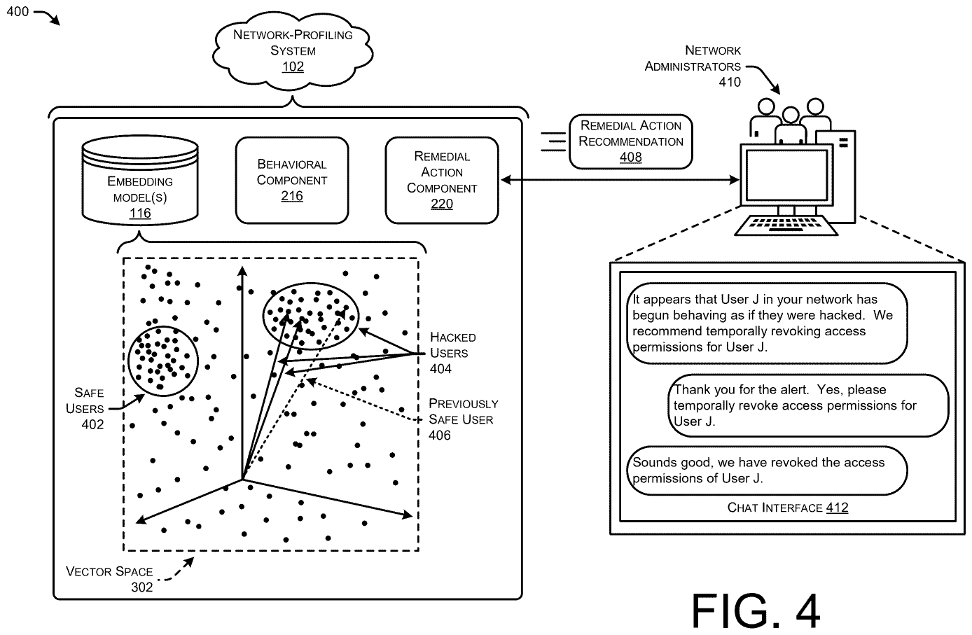

FIG. 4 illustrates an example diagram 400 of a network-profiling system 102 that uses an embedding model 116 to determine if entities 106 are safe or hacked. The network-profiling system 102 may analyze behavior of the entities 106 in vector representations in the vector space 302, detect potentially compromised ones of the entities 106, and determine and generate remedial action recommendations.

In some cases, the network-profiling system 102 (e.g., behavioral component 216) may define clusters in the vector space 302 to categorize entities. The vector space 302 may include a cluster of safe users 402 and a cluster of hacked users 404. These clusters may represent different behavioral patterns exhibited by network entities.

The behavioral component 216 may analyze the positions and movements of vector points within the vector space 302. In some implementations, the behavioral component 216 may examine vectors that move over time to detect changes in behaviors in one or more of the entities 106. For example, the vector space 302 may show a previously safe user 406 that has moved from the cluster of safe users 402 toward the region associated with the cluster of hacked users 404.

The network-profiling system 102 may use cosine similarity between vector representations to determine if any of the entities 106 exhibit similar behavior. Cosine similarity measures the cosine of the angle between two vectors in the vector space. A higher cosine similarity value may indicate that two entities have more similar behavior patterns. For instance, if the cosine similarity between a PLC's vector representation and the normalization vector for PLCs is close to 1, it may suggest that the PLC is behaving as expected. Conversely, if the cosine similarity is closer to 0, it may indicate that the PLC's behavior deviates significantly from the norm, potentially signaling a security issue or malfunction.

The behavioral component 216 may analyze these vector representations and their relationships within the vector space 302. The results of this analysis may be stored in the behavioral results store 218. In some implementations, the remedial action component 220 may use these results to recommend actions when potentially unsafe behaviors are detected based on the positions and movements of vector points in the vector space 302.

When the behavioral component 216 detects concerning behavior, such as a vector point moving towards an unsafe region of the vector space 302, the remedial action component 220 may generate a remedial action recommendation 408. In some cases, the remedial action recommendation 408 may be provided to network administrators 410 through a chat interface 412.

The remedial action recommendations 408 may include one or more actions in a range of actions that are tailored to the severity and nature of the detected behaviors of entities 106 being unsafe or non-compliant (e.g., not following a network policy, a security policy, etc.. For example, the remedial action component 220 may suggest implementing additional authentication measures for a user 106A whose vector representation has moved slightly towards an unsafe region. This could involve requiring multi-factor authentication or reducing access privileges temporarily.

In cases where more significant behavioral changes are detected, the remedial action component 220 may recommend more stringent measures. These may include isolating the affected entity from sensitive network resources, initiating a full security audit of the entity's recent activities, or triggering an immediate password reset and account lockdown. The remedial action component 220 may also provide recommendations for system-wide security enhancements based on observed patterns. For instance, if multiple entities show similar concerning behavior, the component may suggest updating firewall rules, enhancing network segmentation, or deploying additional security monitoring tools to specific network segments.

In some aspects, the remedial action recommendations 408 may include automated response options. The network profiling system 102 may offer network administrators 410 the ability to authorize pre-defined automated responses for certain types of detected anomalies. These automated responses could include temporarily revoking access permissions, initiating backup procedures, or triggering alerts to other security systems.

The remedial action component 220 may prioritize its recommendations based on factors such as the potential impact of the detected anomaly, the criticality of the affected entity, and the confidence level of the detection. This prioritization may help network administrators 410 focus on the most urgent issues first, improving the overall efficiency of the security response process.

The chat interface 412 may display a conversation thread where the network-profiling system 102 alerts the network administrators 410 about potentially compromised users. In some implementations, the chat interface 412 may allow the network administrators 410 to interact with the network profiling system 102, request additional information, or initiate recommended actions.

The network-profiling system 102 may continuously monitor the vector space 302 for changes in entity behavior. In some cases, the network-profiling system 102 may execute instructions stored in the computer-readable media 206 to update the vector space 302 based on new telemetry data 110 and identity data 114 received through the network interface 204.

The behavioral component 216 may use various techniques to analyze the vector space 302. In some implementations, the behavioral component 216 may employ clustering algorithms to identify groups of entities with similar behavior patterns. The behavioral component 216 may also use distance calculations or other metrics to determine if an entity's vector representation has moved significantly from its expected position.

When the behavioral component 216 identifies potentially unsafe behavior, the results may be stored in the behavioral results store 218. The remedial action component 220 may access these results to generate appropriate remedial action recommendations 408. In some cases, the remedial action recommendations 408 may include suggestions for further investigation, access restrictions, or other security measures.

The network-profiling system 102 may provide a comprehensive view of entity behavior across the network. By analyzing the vector space 302, the network-profiling system 102 may detect subtle changes in behavior that might not be apparent through traditional security monitoring methods. This approach may allow for early detection of potential security threats and proactive response to emerging issues.

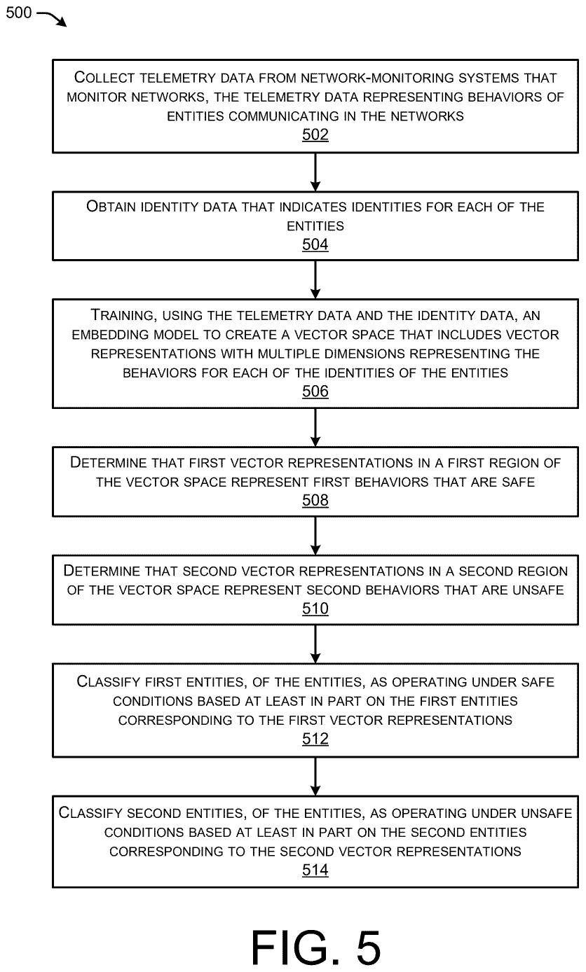

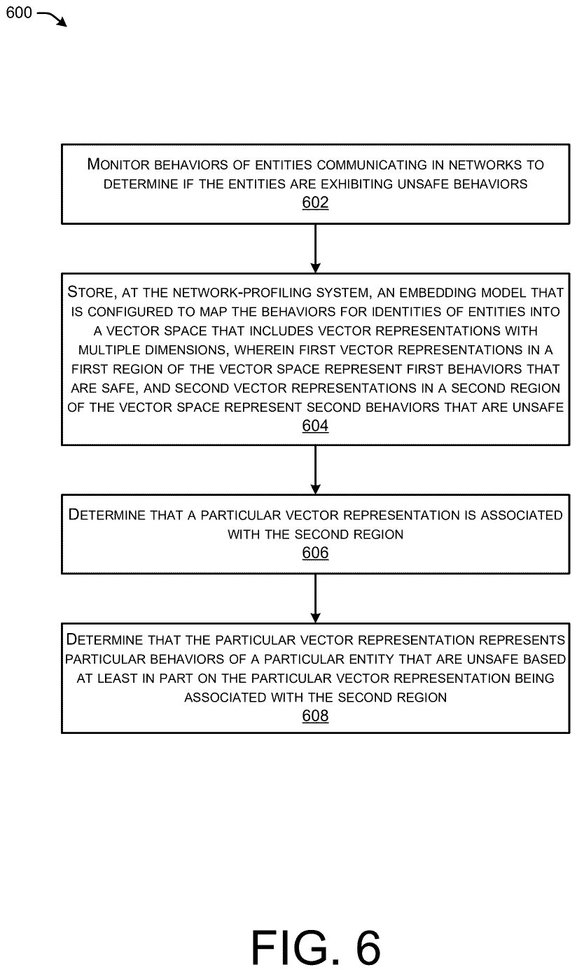

FIGS. 5 and 6 illustrate flow diagrams of an example methods 500 and 600 that illustrates aspect of the functions performed at least partly by the devices described in FIGS. 1-4, such as the network-profiling system 102. The logical operations described herein with respect to FIGS. 5 and 6 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in the FIGS. 5 and 6 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

In some instances, the steps of methods 500 and 600 may be performed by a device and/or a system of devices that includes one or more processors and one or more non-transitory computer-readable media storing computer-executable instructions that, when executed by the one or more processors, cause the one or more processors to perform operations of methods 500 and 600.

FIG. 5 illustrates a flow diagram of an example method 500 for a network-profiling system 102 to create an embedding model 116 configured to profile behaviors of entities 106 communicating using networks.

At 502, the network-profiling system 102 may collect the telemetry data 110 from network-monitoring systems that monitor networks. The telemetry data 110 may represent behaviors of entities communicating in the networks. In some cases, the telemetry component 210 may process the incoming telemetry data 110 from various sources within the network environment.

At 504, the network-profiling system 102 may, obtain identity data 114 that indicates identities for each of the entities. In some implementations, the identity component 212 may process and manage the identity data 114 received from the identity services 112.

At 506, the network-profiling system 102 may train the embedding model 116 using the telemetry data 110 and the identity data 114 to create a vector space 302 that includes vector representations with multiple dimensions representing the behaviors for each of the identities of the entities. In some cases, the training component 214 may utilize the processed telemetry data 110 and identity data 114 to create and update the embedding model 116.

At 508, the network-profiling system 102 may determine that first vector representations in a first region of the vector space 302 represent first behaviors that are safe.

At 510, the network-profiling system 102 may determine that second vector representations in a second region of the vector space 302 represent second behaviors that are unsafe.

At 512, the network-profiling system 102 may classify first entities as operating under safe conditions based at least in part on the first entities corresponding to the first vector representations.

At 514, the network-profiling system 102 may classify second entities as operating under unsafe conditions based at least in part on the second entities corresponding to the second vector representations.

In some cases, the behavioral component 216 may analyze the vector representations produced by the embedding model 116 to identify patterns and anomalies in network behavior. The behavioral component 216 may cluster similar behaviors, detect outliers, and track changes in entity behavior over time.

FIG. 6 illustrates a flow diagram of an example method 600 for a network-profiling system 102 to use an embedding model 116 configured to determine that an entity is behavior unsafe.

At 602, the network-profiling system 102 may monitor behaviors of entities communicating in networks to determine if the entities are exhibiting unsafe behaviors. In some implementations, the telemetry component 210 may continuously collect and process telemetry data 110 from various sources within the network environment.

At 604, the network-profiling system 102 may store the embedding model 116 that may be configured to map the behaviors for identities of entities into the vector space 302 that includes vector representations with multiple dimensions. In the vector space 302, first vector representations in a first region may represent first behaviors that are safe, while second vector representations in a second region may represent second behaviors that are unsafe.

At 606, the network-profiling system 102 may determinate that a particular vector representation may be associated with the second region (e.g., cosine similarity, within a geographic/mathematical boundary or range, etc.). At 608, the network-profiling system 102 may determine that the particular vector representation represents particular behaviors of a particular entity that are unsafe based at least in part on the particular vector representation being associated with the second region.

In some cases, the network profiling system 102 may use algorithms like Support Vector Machine (SVM) to find cluster boundaries in the high-dimensional vector space 302. These algorithms may help define the regions associated with safe and unsafe behaviors, allowing for more accurate classification of entity behaviors.

The network profiling system 102 may fine-tune the vector representations over time as entity behavior changes or new entities are added. This continuous learning process may allow the embedding model 116 to adapt to evolving network behaviors and maintain accurate classifications of safe and unsafe behaviors.

In some implementations, the remedial action component 220 may use the insights generated by the behavioral component 216 to recommend appropriate actions when potentially unsafe behaviors are detected. The remedial action recommendations 408 may be provided to the network administrators 410 through the chat interface 412, allowing for prompt response to potential security threats.

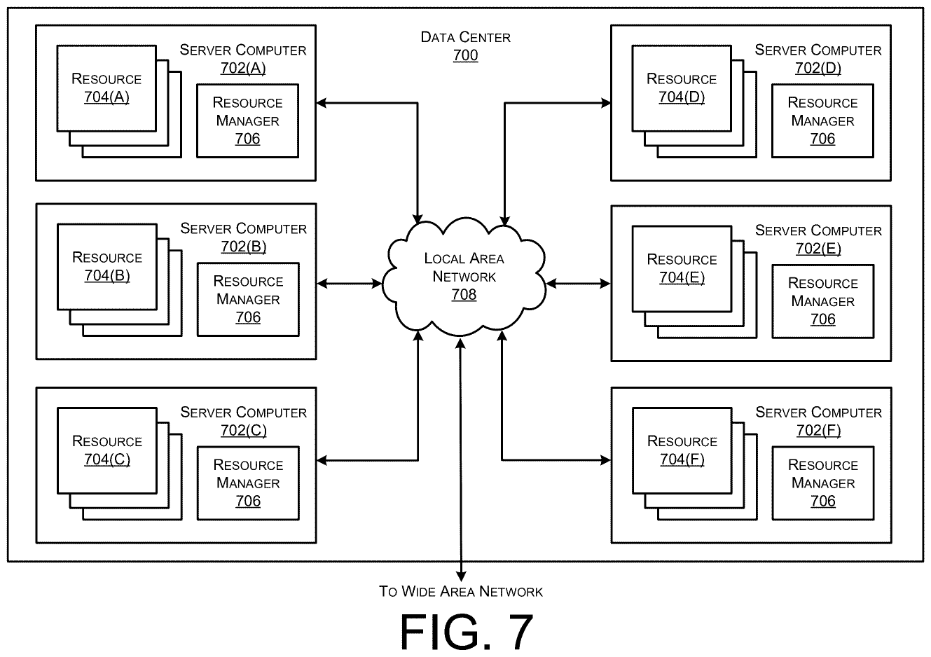

FIG. 7 is a computing system diagram that illustrates one configuration for a data center 700 that implements aspects of the technologies disclosed herein. The example data center 700 shown in FIG. 7 includes several server computers 702A-702F (which might be referred to herein singularly as “a server computer 702” or in the plural as “the server computers 702”) for providing computing resources 704A-704E. In some examples, the resources 704 and/or server computers 702 may include, be included in, or correspond to, devices that support the network-profiling system 102 and/or network-monitoring systems 104 as described herein.

The server computers 702 can be standard tower, rack-mount, or blade server computers configured appropriately for providing the computing resources described herein (illustrated in FIG. 7 as the computing resources 704A-704E). As mentioned above, the computing resources provided by the cloud computing system 102 can be data processing resources such as VM instances or hardware computing systems, database clusters, computing clusters, storage clusters, data storage resources, database resources, networking resources, and others. Some of the servers 702 can also be configured to execute a resource manager 706 capable of instantiating and/or managing the computing resources. In the case of VM instances, for example, the resource manager 706 can be a hypervisor or another type of program configured to enable the execution of multiple VM instances on a single server computer 702. Server computers 702 in the data center 700 can also be configured to provide network services and other types of services.

In the example data center 700 shown in FIG. 7, an appropriate LAN 708 is also utilized to interconnect the server computers 702A-702F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between each of the data centers 700A-700N, between each of the server computers 702A-702F in each data center 700, and, potentially, between computing resources in each of the server computers 702. It should be appreciated that the configuration of the data center 700 described with reference to FIG. 7 is merely illustrative and that other implementations can be utilized.

The data center 700 shown in FIG. 7 also includes a server computer 702F that can execute some or all of the software components described above. For example, and without limitation, the server computer 702F (and the other server computers 702) can generally be included in the network-profiling system 102 of FIG. 1 and be configured to execute components, including the components of the network-profiling system 102 and/or the other components and systems described above. The server computer 702F can also be configured to execute other components and/or to store data for providing some or all of the functionality described herein. In this regard, it should be appreciated that the services illustrated in FIG. 7 as executing on the server computer 702F can execute on many other physical or virtual servers in the data centers 700 in various embodiments.

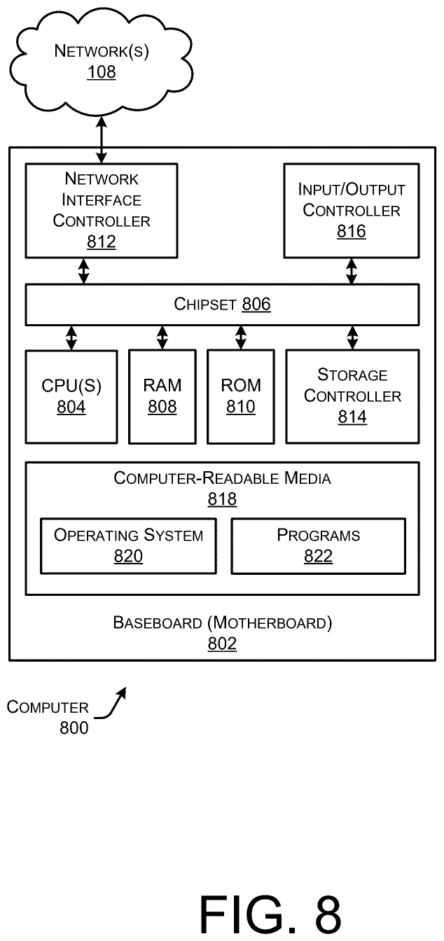

FIG. 8 shows an example computer architecture for a device capable of executing program components for implementing the functionality described above. The computer architecture shown in FIG. 8 illustrates any type of computer 800, such as a conventional server computer, workstation, desktop computer, laptop, tablet, network appliance, e-reader, smartphone, or other computing device, and can be utilized to execute any of the software components presented herein.

As described herein, the network-profiling system 102 may be run on the computer 800, or multiple ones of the computer 800. Similarly, the computer 800 may be any type of device 106B and/or devices supporting the network-profiling system 102 described herein. Thus, the computer 800 may, in some examples, correspond to any device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 800 includes a baseboard 802, or “motherboard,” which is a printed circuit board to which a multitude of components or devices can be connected by way of a system bus or other electrical communication paths. In one illustrative configuration, one or more central processing units (“CPUs”) 804 operate in conjunction with a chipset 806. The CPUs 804 can be standard programmable processors that perform arithmetic and logical operations necessary for the operation of the computer 800.

The CPUs 804 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 806 provides an interface between the CPUs 804 and the remainder of the components and devices on the baseboard 802. The chipset 806 can provide an interface to a RAM 808, used as the main memory in the computer 800. The chipset 806 can further provide an interface to a computer-readable storage medium such as a read-only memory (“ROM”) 810 or non-volatile RAM (“NVRAM”) for storing basic routines that help to startup the computer 800 and to transfer information between the various components and devices. The ROM 810 or NVRAM can also store other software components necessary for the operation of the computer 800 in accordance with the configurations described herein.

The computer 800 can operate in a networked environment using logical connections to remote computing devices and computer systems through a network, such as the network(s) 108. The chipset 806 can include functionality for providing network connectivity through a NIC 812, such as a gigabit Ethernet adapter. The NIC 812 is capable of connecting the computer 800 to other computing devices over the network(s) 108. It should be appreciated that multiple NICs 812 can be present in the computer 800, connecting the computer to other types of networks and remote computer systems.

The computer 800 can be connected to a storage device 818 that provides non-volatile storage for the computer. The storage device 818 can store an operating system 820, programs 822, and data, which have been described in greater detail herein. The storage device 818 can be connected to the computer 800 through a storage controller 814 connected to the chipset 806. The storage device 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 800 can store data on the storage device 818 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 818 is characterized as primary or secondary storage, and the like.

For example, the computer 800 can store information to the storage device 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 800 can further read information from the storage device 818 by detecting the physical states or characteristics of one or more particular locations within the physical storage units.

In addition to the mass storage device 818 described above, the computer 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 800. In some examples, the operations performed by the network-profiling system 102, and/or any components included therein, may be supported by one or more devices similar to computer 800. Stated otherwise, some or all of the operations performed by network-profiling system 102, and or any components included therein, may be performed by one or more of the computer 800.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 818 can store an operating system 820 utilized to control the operation of the computer 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 818 can store other system or application programs and data utilized by the computer 800.

In one embodiment, the storage device 818 or other computer-readable storage media is encoded with computer-executable instructions which, when loaded into the computer 800, transform the computer from a general-purpose computing system into a special-purpose computer capable of implementing the embodiments described herein. These computer-executable instructions transform the computer 800 by specifying how the CPUs 804 transition between states, as described above. According to one embodiment, the computer 800 has access to computer-readable storage media storing computer-executable instructions which, when executed by the computer 800, perform the various processes described above with regard to FIGS. 1-7. The computer 800 can also include computer-readable storage media having instructions stored thereupon for performing any of the other computer-implemented operations described herein.

The computer 800 can also include one or more input/output controllers 816 for receiving and processing input from a number of input devices, such as a keyboard, a mouse, a touchpad, a touch screen, an electronic stylus, or other type of input device. Similarly, an input/output controller 816 can provide output to a display, such as a computer monitor, a flat-panel display, a digital projector, a printer, or other type of output device. It will be appreciated that the computer 800 might not include all of the components shown in the figures, can include other components that are not explicitly shown in FIG. 8, or might utilize an architecture completely different than that shown in FIG. 8.

As described herein, the computer 800 may comprise one or more of the network-profiling system 102, the devices 106B, and/or any other device. The computer 800 may include one or more hardware processors 804 (processors) configured to execute one or more stored instructions. The processor(s) 804 may comprise one or more cores. Further, the computer 800 may include one or more network interfaces configured to provide communications between the computer 800 and other devices, such as the communications described herein as being performed by the network-profiling system 102. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 822 may comprise any type of programs or processes to perform the techniques described in this disclosure.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method for a network-profiling system to create an embedding model configured to profile entities communicating using networks, the method comprising:
collecting telemetry data from network-monitoring systems that monitor the networks, the telemetry data representing behaviors of the entities communicating in the networks;
obtaining identity data that indicates identities for each of the entities;
using the telemetry data and the identity data, training an embedding model to map the behaviors for each of the identities of the entities into a vector space that includes vector representations with multiple dimensions;
determining that first vector representations in a first region of the vector space represent first behaviors that are safe;
determining that second vector representations in a second region of the vector space represent second behaviors that are unsafe;
classifying first entities, of the entities, as operating under safe conditions based at least in part on the first entities corresponding to the first vector representations; and
classifying second entities, of the entities, as operating under unsafe conditions based at least in part on the second entities corresponding to the second vector representations.

2. The method of claim 1, further comprising:
determining that a particular vector representation is associated with the second region; and
determining that the particular vector representation represents particular behaviors of a particular entity that are unsafe based at least in part on the particular vector representation being associated with the second region.

3. The method of claim 2, further comprising alerting a network administrator associated with the particular entity that the particular entity is unsafe.

4. The method of claim 2, further comprising restricting at least one of access permissions or communication permissions of the particular entity in at least one of the networks based at least in part on determining that the particular entity is unsafe.

5. The method of claim 1, wherein:
the entities include:
physical devices communicating using the networks;
applications running on the physical devices; and
users that communicate using user devices and over the networks; and
the telemetry data includes one or more of access logs, traffic flow logs, network security monitoring logs, network incident logs, device profiling data, user profiling data, system log files, application use data, and enterprise network data.

6. The method of claim 1, further comprising:
generating first training data by associating a first identity of the identities with a first log entry included in the telemetry data collected by a first network-monitoring system of the network-monitoring systems; and
generating second training data by associating a second identity of the identities with a second log entry included in the telemetry data collected by a second network-monitoring system of the network-monitoring systems;
wherein:
the first log entry represents a first behavior of the first identity and the second log entry represents a second behavior of the second identity and the second log entry;
and
training the embedding model to create the vector space that includes vector representations with multiple dimensions representing the behaviors for each of the identities of the entities includes using the first training data and the second training data.

7. The method of claim 1, further comprising:
determining that at least one of the telemetry data or the identity data includes Personally Identifiable Information (PII) data associated with at least one of the entities; and
obfuscating the PII data prior to using the telemetry data and the identity data to train the embedding model.

8. A network-profiling system that creates an embedding model configured to profile entities communicating using networks, the network-profiling system comprising:
one or more processors; and
one or more computer-readable media storing computer-executable instructions that, when executed by the one or more processors, cause the network-profiling system to perform operations comprising:
collecting telemetry data from network-monitoring systems that monitor the networks, the telemetry data representing behaviors of the entities communicating in the networks;
obtaining identity data that indicates identities for each of the entities;
using the telemetry data and the identity data, training an embedding model to map the behaviors for each of the identities of the entities into a vector space that includes vector representations with multiple dimensions;
determining that first vector representations in a first region of the vector space represent first behaviors that are safe;
determining that second vector representations in a second region of the vector space represent second behaviors that are unsafe;
classifying first entities, of the entities, as operating under safe conditions based at least in part on the first entities corresponding to the first vector representations; and
classifying second entities, of the entities, as operating under unsafe conditions based at least in part on the second entities corresponding to the second vector representations.

9. The network-profiling system of claim 8, the operations further comprising:
determining that a particular vector representation is associated with the second region; and
determining that the particular vector representation represents particular behaviors of a particular entity that are unsafe based at least in part on the particular vector representation being associated with the second region.

10. The network-profiling system of claim 9, the operations further comprising alerting a network administrator associated with the particular entity that the particular entity is unsafe.

11. The network-profiling system of claim 9, the operations further comprising restricting at least one of access permissions or communication permissions of the particular entity in at least one of the networks based at least in part on determining that the particular entity is unsafe.

12. The network-profiling system of claim 8, wherein:
the entities include:
physical devices communicating using the networks;
applications running on the physical devices; and
users that communicate using user devices and over the networks; and
the telemetry data includes one or more of access logs, traffic flow logs, network security monitoring logs, network incident logs, device profiling data, user profiling data, system log files, application use data, and enterprise network data.

13. The network-profiling system of claim 8, the operations further comprising:
generating first training data by associating a first identity of the identities with a first log entry included in the telemetry data collected by a first network-monitoring system of the network-monitoring systems; and
generating second training data by associating a second identity of the identities with a second log entry included in the telemetry data collected by a second network-monitoring system of the network-monitoring systems;
wherein:
the first log entry represents a first behavior of the first identity and the second log entry represents a second behavior of the second identity and the second log entry;
and
training the embedding model to create the vector space that includes vector representations with multiple dimensions representing the behaviors for each of the identities of the entities includes using the first training data and the second training data.

14. The network-profiling system of claim 8, the operations further comprising:
determining that at least one of the telemetry data or the identity data includes Personally Identifiable Information (PII) data associated with at least one of the entities; and
obfuscating the PII data prior to using the telemetry data and the identity data to train the embedding model.

15. A method for a network-profiling system to use an embedding model to profile entities communicating using networks, the method comprising:
monitoring behaviors of entities communicating in networks to determine if the entities are exhibiting unsafe behaviors;
storing, at the network-profiling system, an embedding model that is configured to map the behaviors for identities of entities into a vector space that includes vector representations with multiple dimensions, wherein:
first vector representations in a first region of the vector space represent first behaviors that are safe; and
second vector representations in a second region of the vector space represent second behaviors that are unsafe;
determining that a particular vector representation is associated with the second region; and
determining that the particular vector representation represents particular behaviors of a particular entity that are unsafe based at least in part on the particular vector representation being associated with the second region.

16. The method of claim 15, further comprising alerting a network administrator associated with the particular entity that the particular entity is unsafe.

17. The method of claim 15, further comprising restricting at least one of access permissions or communication permissions of the particular entity in at least one of the networks based at least in part on determining that the particular entity is unsafe.

18. The method of claim 15, further comprising:
collecting telemetry data from network-monitoring systems that monitor the networks, the telemetry data representing the behaviors of the entities communicating in the networks;
obtaining identity data that indicates the identities for each of the entities;
using the telemetry data and the identity data, training the embedding model to map the behaviors for each of the identities of the entities into the vector space;
determining that first vector representations in a first region of the vector space represent first behaviors that are safe;
determining that second vector representations in a second region of the vector space represent second behaviors that are unsafe;
classifying first entities, of the entities, as operating under safe conditions based at least in part on the first entities corresponding to the first vector representations; and
classifying second entities, of the entities, as operating under unsafe conditions based at least in part on the second entities corresponding to the second vector representations.

19. The method of claim 18, wherein:
the entities include:
physical devices communicating using the networks;
applications running on the physical devices; and
users that communicate using user devices and over the networks; and
the telemetry data includes one or more of access logs, traffic flow logs, network security monitoring logs, network incident logs, device profiling data, user profiling data, system log files, application use data, and enterprise network data.

20. The method of claim 18, further comprising:
determining that at least one of the telemetry data or the identity data includes Personally Identifiable Information (PII) data associated with at least one of the entities; and
obfuscating the PII data prior to using the telemetry data and the identity data to train the embedding model.
